(19) United States
(12) Patent Application Publication
(10) Pub. No.: US 2008/0015823 A1
(43) Pub. Date: Jan. 17, 2008

(54) EXTENSIBLE BUILDING INFORMATION MODEL TOOLSET

(75) Inventors: Andrew Andrew Arnold, Oakland, CA (US); Blaine Wishart, Mill Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Tectonic Network, Inc., Atlanta, GA (US)

(21) Appl. No.: 11/764,142

(22) Filed: Jun. 15, 2007

Related U.S. Application Data
(60) Provisional application No. 60/805,048, filed on Jun. 16, 2006.

(51) Int. Cl. G06F 17/50

(52) U.S. Cl. 703/1

(57) ABSTRACT

A building information management (BIM) system is provided with a library platform that supports a toolset with novel functionality. Embodiments of the invention provide a library of products that can be used in a BIM and provide a virtual product set with improved functionality and more detailed information about the products. The library of products includes virtual products that comprise parametrically described data objects. The toolset includes an editor with which the virtual products can be edited and modified. The library of virtual products can be configured for interoperability with multiple BIM systems.

### CROSS-REFERENCE TO RELATED APPLICATIONS

This application claims the benefit of priority of co-pending U.S. Provisional Patent Application Ser. No. 60/805,403 entitled “Extensible Building Virtualization Toolset”, by James Andrew Arnold, et al. filed Jun. 16, 2006. Priority of the filing date of Jun. 16, 2006 is hereby claimed, and the disclosure of the Provisional Patent Application is hereby incorporated by reference.

### BACKGROUND

1. Field of the Invention

The present invention relates generally to information model authoring systems and, more particularly, computer tools for interaction with data produced from building information model (BIM) authoring systems.

2. Related Art

Computer-implemented tools for design are well-known. For example, computer aided design (CAD) application programs are used for generic design and also for specialized systems such as architecture, engineering, and construction (AEC) systems. For the AEC environment, CAD application programs are widely used for the creation and modification of complex building structures and their components, including HVAC (heating, ventilation, and air conditioning) systems, plumbing and piping systems, electrical systems, communications networks, walls, doors, windows, and the like. CAD systems for AEC projects are evolving into building information model (BIM) authoring systems, in which the BIM includes construction drawings for a building or construction project and can also include data that describes the components parts that will be used in the construction effort. One such BIM authoring application is the software product known as Revit® available from Autodesk, Inc. of San Rafael, Calif., USA.

Most BIM software applications permit designing building structures such as homes and commercial structures such as office buildings and the like, as well as construction projects such as public infrastructure. Such software applications typically provide a collection of building element models such as walls, windows, doors, ducting, columns, fixtures, and so forth. The building element models typically include geometry for components to enable 3D visualization of the building and rudimentary non-geometric attribute data. When placed in a BIM, building element models permit the construction of databases for a building project that are useful during design, construction, and subsequent operations and maintenance phases of the building life cycle.

BIM systems could be better utilized with tools that permit greater flexibility in utilizing building element libraries and creating BIM databases. For example, detailed information on component pricing, vendors, part numbers, and the like are typically not available with conventional BIM libraries, but could be useful. In addition, many BIM systems and their associated files and databases are proprietary in nature and cannot easily interface with alternative BIM systems. In view of the discussion above, it should be apparent that there is a need for greater flexibility and variety in the tools available for interaction with BIM systems. The present invention satisfies this need.

### SUMMARY

Embodiments of the invention provide an extensible platform for managing building information models and provide supporting toolsets with novel functionality. The extensible platform interfaces with content from an associated building information model (BIM) authoring application. The extensible platform can collect, associate, and manage building element model (BEM) information from the BIM application and from multiple sources, for manipulation and viewing of the BEM information with respect to the BIM content, and can interact with applications and tools implemented as extensions of the platform. In this way, the extensible platform provides a flexible core from which tailored applications can be extended to perform desired tasks involving multiple data sources.

The extensible platform can be implemented as a Library Manager application that operates with a core collection of five viewer classes comprising viewers of the Library Manager application. The viewers include a Library Tree View, a Thumbnail View, a Guideline View, a DWF Image View, and a Properties View. Each viewer can render a display of a particular associated file type from the BIM content as panes of the Library Manager. For example, the Library Tree View class can process xml files, the Thumbnail View class can process image files such as JPEG, the Guideline View can process text files such as html, the DWF Image View can process 3D files such as *.dwf files, and the Properties View can process xml files. The viewers are implemented as plug-in applications for the Library Manager and can be manipulated for display purposes on the host computer of the user.

The BIM content files that are accessed by the Library Manager relate to a BIM authoring application, such as the Revit®t software product available from Autodesk, Inc. of San Rafael, Calif., USA. The content files are located appropriately relative to the user host computer for efficient retrieval and processing by the Library Manager. The collection of content files comprises a Library of BEM objects that are parameterized components of the BIM application. Data for library files can be generated by a Content Publisher that locates and processes the corresponding BEM files of a BIM application. The Content Publisher can ensure that data for all five class types for the Library Manager are available.

The collected Library of BEM objects incorporates additional data from external sources. They can be used in a BIM authoring application and provide a set of BEMs with improved functionality and more detailed information as compared with conventionally available BEMs for BIM authoring applications. The Library of improved BEMs includes generic and manufacturer-specific models of building products that are represented parametrically. The toolset includes an editor with which the BEMs can be edited and modified. The Library can be configured for interoperability with multiple BIM systems. In this way, users of BIM systems can enjoy greater flexibility and variety in the tools available for interaction with BIM systems.

Other features and advantages of the present invention should be apparent from the following description of exemplary embodiments, which illustrate, by way of example, aspects of the invention.

### BRIEF DESCRIPTION OF THE DRAWINGS

FIG. 1 is a block diagram illustration of a computer-implemented extensible platform comprising a Library Manager constructed in accordance with the present invention.

FIG. 2 is a block diagram of the FIG. 1 extensible platform Library Manager configured for client-server operation.

FIG. 3 is an illustration of a library toolset extended from the extensible platform Library Manager constructed in accordance with the present invention for distributed data access.

FIG. 4 is an illustration of a library toolset extended from the extensible platform Library Manager constructed in accordance with the present invention with a Quantity Take-Off application.

FIG. 5 is an illustration of a library toolset extended from the extensible platform Library Manager constructed in accordance with the present invention with a library manager for market data reporting.

FIG. 6 is a screenshot of a computer display showing the five panes of the Library Manager window for the systems depicted in FIGS. 1-5.

FIG. 7 is a depiction of the framework layers of the Library Manager and extended applications for the user computers of FIGS. 1-5.

FIG. 8 is a representation of the system model implemented by the extensible platform Library Manager of FIGS. 1-5.

FIG. 9 is a representation of the domain model implemented by the extensible platform Library Manager of FIGS. 1-5.

FIG. 10 is a screenshot of the Library Manager window showing details for a configuration group of panes.

FIG. 11 is a screenshot of the Library Manager window for a configuration similar to that of FIG. 10 except for the exchange of the Properties view for the DWF view in the foreground.

FIG. 12 is a screenshot of the Library Manager window showing the Quantity and Take-Off assembly editor extension plug-in.

FIG. 13 is an illustration of a BIM toolset for use with the systems illustrated in FIGS. 1-5.

FIG. 14 is an illustration of a Quantity Take-Off Toolset extension for tracking usage of component parts with the systems illustrated in FIG. 1-5.

FIG. 15 is an illustration of the information work flow of the Quantity Take-Off Toolset extension for the systems illustrated in FIGS. 1-5.

FIG. 16 is an illustration of a computer display of information maintained by the FIG. 1 system for an exemplary named assembly called “exterior wall”.

FIG. 17 is an illustration of a computer display for the “exterior wall” assembly of FIG. 6 showing the addition of further assembly details.

FIG. 18 is a flowchart of operations performed by the system illustrated in FIGS. 1 to 5 for producing a BEM display and to produce cost estimates using the parameterized products in accordance with the invention.

### DETAILED DESCRIPTION

Embodiments of the invention provide an extensible platform for managing building information models (BIM) that supports toolsets with novel functionality. The platform is weaved together from technologies and services that can interact through network communications such as the Internet and that adopt distributed objects, hardware, device, and platform-independent frameworks. The marketplace often uses “Web 2.0” to refer to these features collectively, though there is no single standard that applies to all the technologies encompassed within that nomenclature.

The extensible platform can be provided as a library manager for collections of building element models (BEM) that can be placed in a BIM. The collections of BEMs can be stored in a BEM content Library. The content Library provides parametrically defined models and detailed information about BEMs, created as generic or manufacturer-specific representations of products and assemblies of products. Such parametrically defined products will be referred to as virtual products. The Library can be delivered with the Library Manager, either already populated with content, or the user can generate content using an auxiliary application such as a Content Publisher application that works as an addition to the BIM authoring tool. For example, the Content Publisher can be integrated with the BIM authoring tool so that the Content Publisher appears as a menu option for the toolbar of the authoring tool window. The toolset provided with the Library Manager includes an editor with which the BEMs can be edited and modified. The Library of virtual products can be configured for interoperability with multiple BIM systems. In this way, users of BIM systems can enjoy greater flexibility and variety in the tools available for interaction with BIM systems.

Users of the toolset can programmatically generate a library of BEMs including data models from information that exists in CAD file formats, a variety of building product vendors, and other data sources. The CAD file data may exist in the user's file system or in a BIM that represents a design project. The BEMs include 3D geometry Computer Aided Design (CAD) representations of physical products and assemblies, such as windows and doors, and non-geometric product information that may be represented in the CAD model or integrated from external databases and forms of digital media. The BEMs may contain other BEMs, rules for calculating quantities and unit costs, and the ability to represent predicted and measured product performance behavior for engineering analysis.

Users of the Library Manager also can dynamically add attributes to BEMs and thereby extend and enrich their definition. Users that programmatically generate and manage libraries of the BEMs can customize libraries through different classification systems and via customization of the library user interface for navigating to BEMs for different markets and regions. The toolset can be used to generate a variety of BEM library user interfaces from data that exists in a variety of formats and BIM systems. For example, supported BIM systems and file formats can include the Revit® system from Autodesk, Inc., which provides 3D representations of building components. The toolset can interface with non-CAD data including information relating to price, availability, sustainability, energy analysis, assembly parts, product specifications, sizing concerns, vendor part numbers, and the like. With the toolset, users can find, search, and select BEMs from a library, and place selected BEMs in a BIM authoring system such as the Revit® application from Autodesk, Inc. The toolset and support systems can be configured to collect BEM usage and behavior as market data, which can be used to support sales lead generation and demand forecasting for building product manufacturers.

In accordance with the invention, a computer-implemented building information management system includes a Library that contains BEMs that comprise parametrically described data objects that represent components of a building and are processed by a BIM authoring application to produce a set of instances of the data objects, thereby providing a model-based representation of the building such that the representation can be viewed and manipulated by a user. The extensible computer-implemented building information management system also includes a quantity take-off plug-in that extends the Library Manager kernel. The QTO plug-in extends the metaphor of a Library from manager of BEM definitions in the file system or a BIM, to manager of BEM instances placed in a BIM. The QTO application extends the Library Manager to a quantity take-off application by (1) filtering the presentation of BEMS to those placed in a project; (2) Adding the ability to load, map, and display unit line items from arbitrary line item databases; (3) Providing a drag-and-drop mechanism to associate unit line items to BEMS; (4) Adding an assembly editor and unit line item calculator to describe constituent items of BEM assemblies that aren't represented explicitly in a BIM authoring system and create rules to calculate quantities of constituent unit line items. The assembly editor enables the definition of multiple building assemblies, wherein a building assembly comprises a data object with rules that determine quantity information concerning piece parts contained in the building assembly, and wherein the building assemblies determine the model-based representation of the building, and a user interface with which a user can access the Library Manager software application and the BEM Library to specify the parameterized instances and the building assemblies for processing by the software application.

In another aspect, embodiments of the invention provide a BIM system that can be operated by accessing a Library through a user interface, wherein the Library contains virtual products that comprise parametrically described data objects that represent components of a building, defining multiple building assemblies, wherein a building assembly comprises a data object with inference rules that determine quantity information concerning piece parts contained in the building assembly, and wherein the building assemblies determine a virtual representation of the building, and producing a set of parameterized instances of the data objects and building assemblies for processing by a Library Manager application, thereby providing a virtual representation of a building such that the virtual representation can be viewed and manipulated by a user through the user interface.

In another aspect, embodiments of the invention provide a computer-implemented building information management system comprising a user interface with which a user can access a Library Manager application and a BEM library, a data loader that communicates with a computer network to access a user's collection of BEM models and provide appropriate data objects to a Library Manager application, wherein the user collection of BEM models contains BEMs that comprise parametrically described data objects that represent components of a building and are processed by the Library Manager application to produce a library of the data objects, a user interface generator that processes the provided data objects to produce a computer display presentation of the corresponding BEMs, thereby providing a representation of the building such that the representation can be viewed and manipulated by a user through the user interface, and an assembly editor that operates on the BEMs to define multiple building assemblies, wherein a building assembly comprises a data object with rules that determine quantity information concerning piece parts contained in the building assembly, and wherein the building assemblies determine the representation of the building.

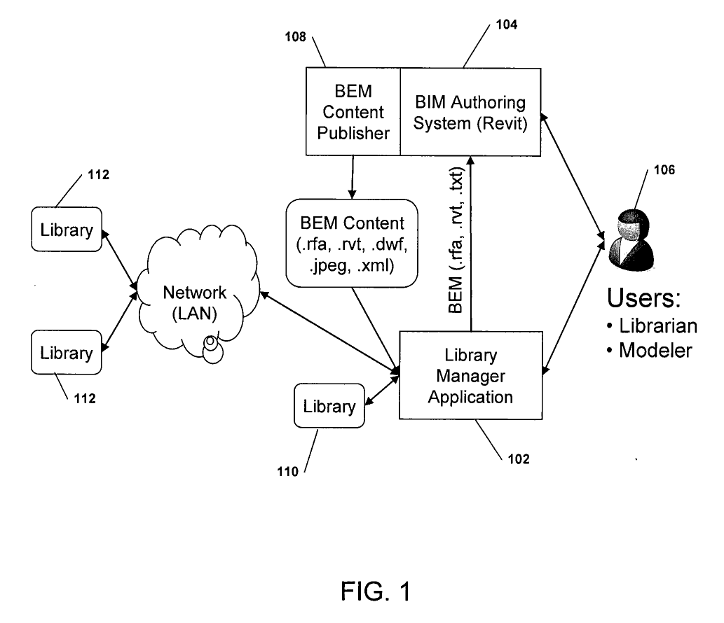

FIG. 1 is a representation of an extensible platform constructed in accordance with the invention, wherein the extensible platform comprises a Library Manager application 102 that is used in conjunction with a BIM authoring system 104, such as the Revit® application referred to above. The Library Manager application and the BIM authoring system are typically utilized by users 106 such as modelers and librarians with responsibility for maintaining the libraries used by such authoring tools. The Library Manager application typically is installed on a host computer through which the user operates the application. The Library Manager 102 receives BEM information from the BIM authoring system 104, indicated by the arrow in FIG. 1 connecting the two blocks. The arrow is labeled with exemplary file types for the data files that are received by the Library Manager, including *.rfa, *.rvt, and *.txt.

A BEM Content Publisher 108 is an adapter that can create content for the Library Manager 102, based on data formats from the BIM authoring system 104 and from other data sources such as libraries. The Content Publisher can operate with the BIM authoring system so as to find the appropriate files created with the system and place them in the correct format and storage location for use by the Library Manager. For example, the authoring system will typically store BIM files using the file system of the host computer. The output of the BEM Content Publisher as indicated in FIG. 1 shows that the output file types include *.rfa, *.rvt, *.dwf, *.jpeg, and *.xml.

The Library Manager 102 will include a data loader component, a user interface view generation component, a user interface navigation generation component, and a search engine component (not illustrated). The Library Manager can save the output of its processing, and the collection of files comprising a product Library, to the local disk 110 at the user computer, or can save the product Library files to a network location 112, for data storage that is shared over a data network.

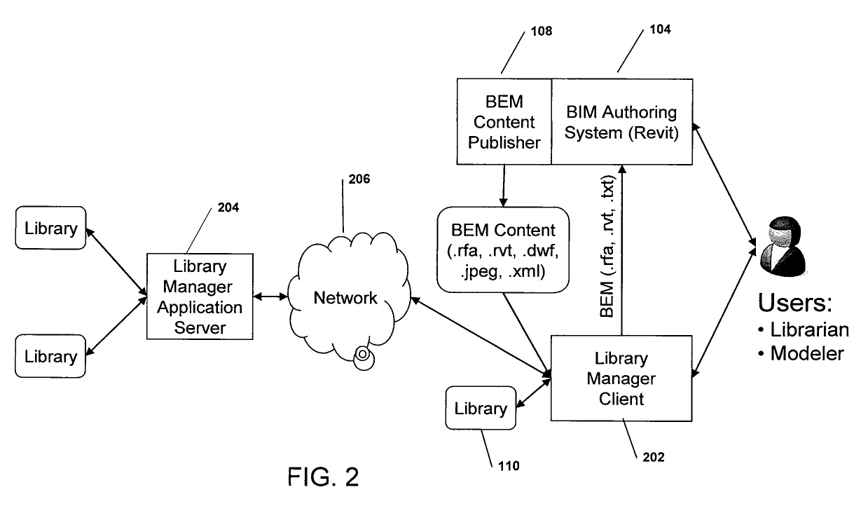

FIG. 2 is a block diagram of the FIG. 1 extensible platform Library Manager configured for client-server operation. That is, the FIG. 2 configuration is similar to that of FIG. 1, except that whereas FIG. 1 is configured for a Library Manager application that is installed at a user's computer (such as a desktop or laptop computer), the FIG. 2 configuration implements the Library Manager at the user computer as a client machine 202, while a Library Management application server 204 communicates with the client over a network 206. The FIG. 2 configuration follows client-server considerations to control intra-office and intra-firm libraries, includes user access rules, performs workflow management, administers file access rules, and provides a notification system for available content. The system of FIG. 2 may deploy the application server 204 to a variety of configurations, as desired. For example, the system may deploy an application server image to the Amazon Elastic Computer Cloud service for on-demand requisition of server capacity.

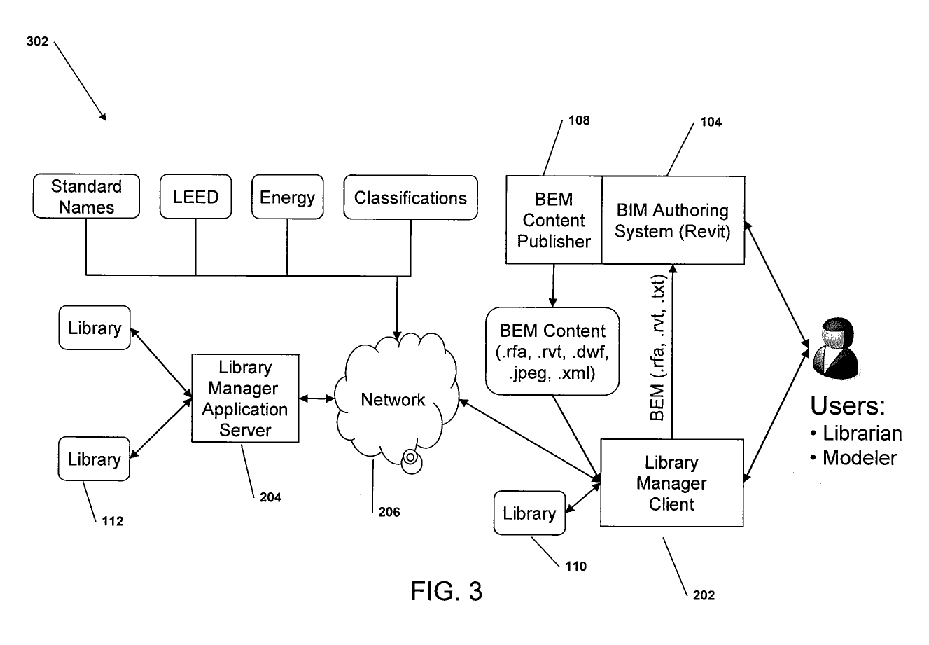

FIG. 3 is an illustration of a library toolset extended from the extensible platform Library Manager constructed in accordance with the present invention for distributed data access. The FIG. 3 configuration again uses the client-server model, as in FIG. 2, except that in the FIG. 3 embodiment, external sources 302 of data are shown, and are mapped from the external sources to the BEM models represented in the Library (which may comprise files stored locally 110 at the host and over one or more network locations 112). FIG. 3 shows that a variety of sources 302 can contribute to the data that can be viewed and manipulated by the Library Manager, including sources such as existing library databases for 3D geometries and shapes and materials (standard names), LEED specification for environmental or “green” ratings, energy, and other classifications.

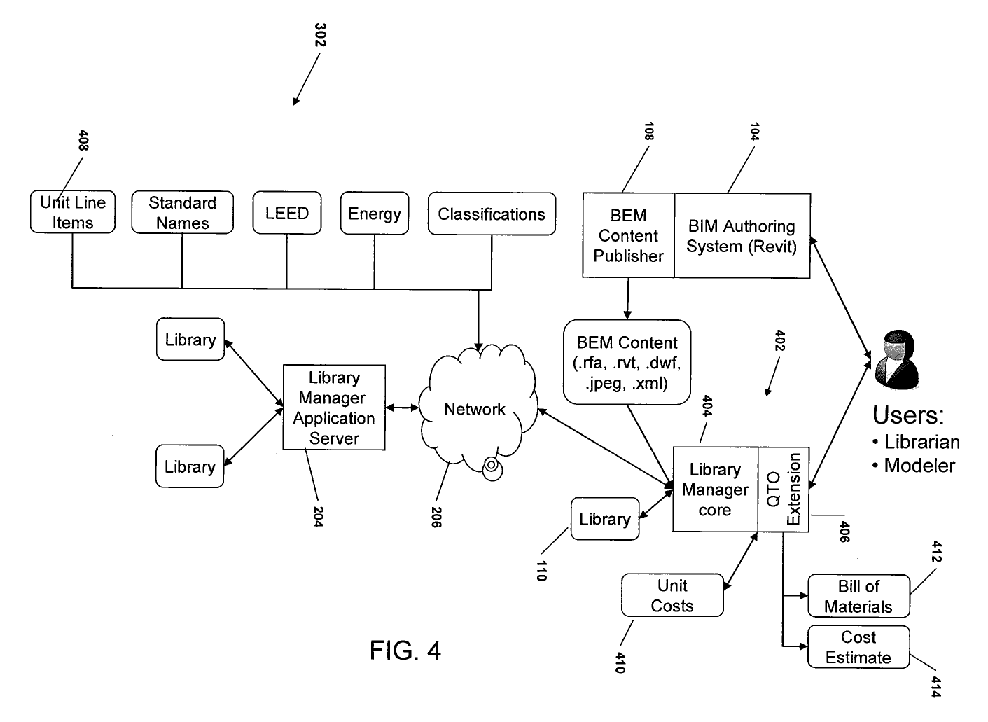

FIG. 4 is an illustration of a library toolset extended from the extensible platform Library Manager constructed in accordance with the present invention for client-server operation with a Library Manager for distributed data access. The Library Manager 402 of FIG. 4 includes the core library functionality 404 as described previously, but also includes a “Quantity Take-Off” component 406 that obtains the usual core data but also receives data on unit line items 408 and unit costs 410. In FIG. 4, the Library Manager 402 also includes a BEM editor component, an assembly editor component, and a quantity rule editor (not illustrated in FIG. 4). The Library Manger, through the QTO extension 406, can produce output reports that provide bill of materials information 412 for the BIM and corresponding cost estimates 414.

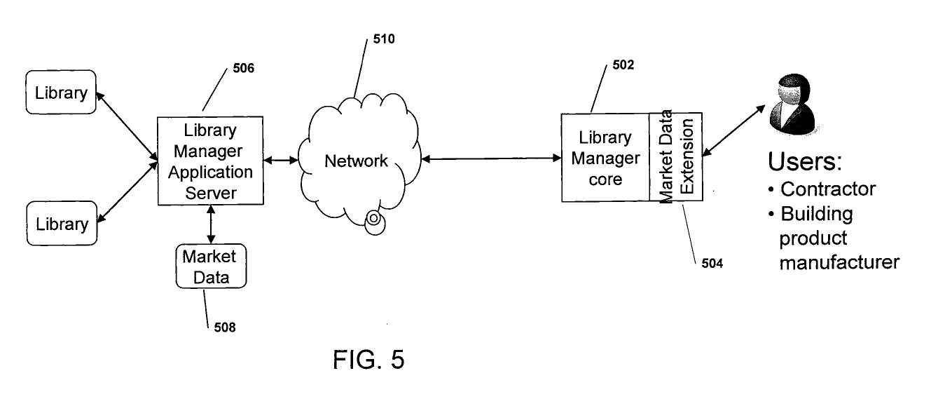

FIG. 5 is an illustration of a library toolset extended from the extensible platform Library Manager constructed in accordance with the present invention with a library manager for market data deployment. In FIG. 5, the Library Manager core 502 includes a Market Data Manager 504 that aggregates data and generates reports. In FIG. 5, the Library Manager application server 506 is shown interfacing with a market data store 508, which the application server communicates to the Library Manager client 502 (at the user) over the network 510. The network may comprise, for example, an intra-office network or a widespread network, such as the Internet.

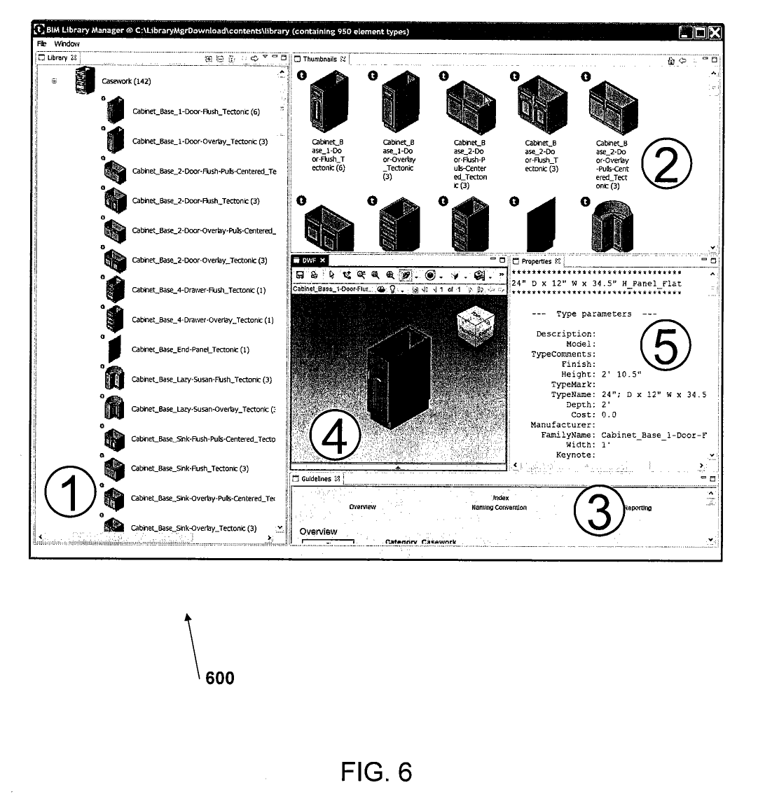

Any one of the systems configured in FIGS. 1-5 when executing the Library Manager described herein will produce a display on the host computer that includes a different pane for each data type. FIG. 6 shows an exemplary computer display for the Library Manager.

FIG. 6 is a screenshot of a computer display 600 showing the five panes of the Library Manager window for the systems depicted in FIGS. 1-5, presented on a display of the user host computer. In FIG. 6, the panes are labeled with numerals for easier identification, but it should be understood that the numerals are not presented on the computer display during operation. The pane (1) is a Library Tree view that shows available BEMs from the project. The pane (2) is a Thumbnail view that shows thumbnail illustrations of the selected BEMs from the associated BIM application. The pane (3) is a Guidelines view that provides information that assists users in naming conventions and the like for BEM components. The pane (4) is a DWF Image view (referred to herein as simply “DWF view”) that corresponds to a 3D viewer application. The pane (5) is a Properties view that provides information about properties for the selected BEM component. The FIG. 6 screenshot is produced at the display of the host computer for the Library Manager.

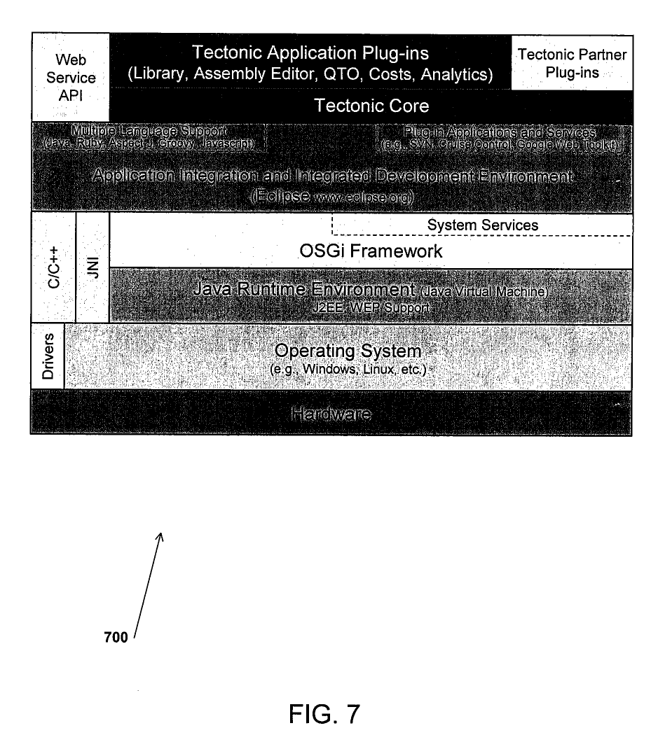

FIG. 7 is a depiction of the framework layers/toolsets of the Library Manager and extended applications for the user computers of FIGS. 1-5. The framework layers/toolsets will be familiar to those skilled in the art. FIG. 7 shows the installation of the Library Manager and associated machine characteristics relative to the other components of the host computer. At the bottom of the FIG. 7 layer model lies the hardware level. Operating on the hardware is the operating system and associated drivers. A combination Java Runtime environment and OSGi Framework occupy the next level, followed by an application integration environment, such as provided by the Eclipse programming integrated development and application integration toolset. On top of the Eclipse layer, the Tectonic core provides Library Manager functionality and an interface to the extended plug-ins. The plug-ins may comprise, for example, quantity take-off and marketing data information applications that can interoperate with the Library Manager to provide additional functionality for library operations.

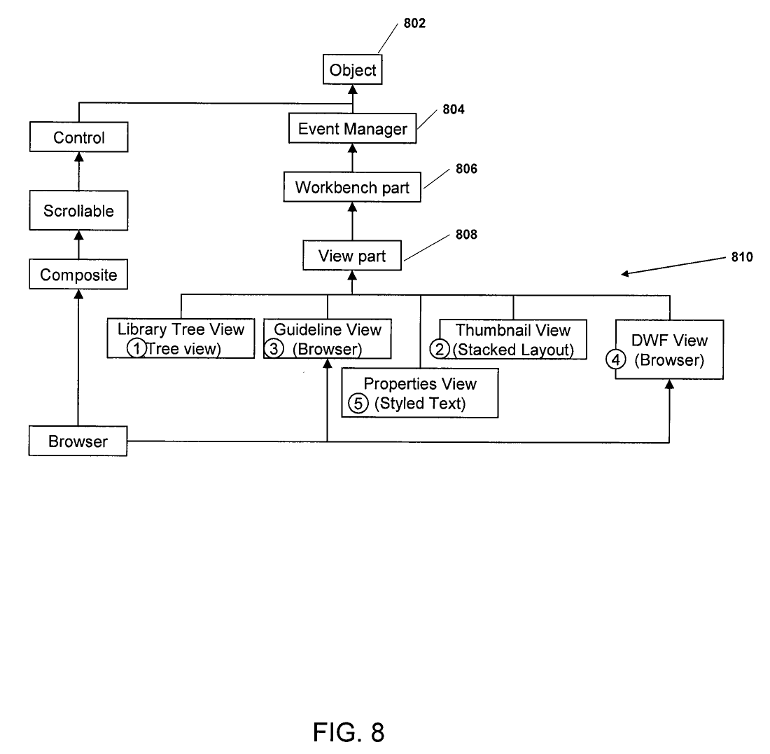

FIG. 8 is a representation of the system model implemented by the extensible platform Library Manager of FIGS. 1-5. The diagram block labeled “Object” 802 illustrates the interface to the Java classes in the middle layers shown in FIG. 7. The Event Manager 804, Workbench part 806, and View part 808 are components of the Eclipse standard, which will be familiar to those skilled in the art. The five components (classes) 810 of the Library Manager are represented in FIG. 8 by the tree view components labeled as “Library Tree View” (1), Thumbnail View (2), Guideline View (3), DWF View (4), and Properties View (5). Each of these Views represents a view of the underlying system and domain model. The view numbers (1, 2, . . . , 5) correspond to the panes illustrated in FIG. 6, which are produced by the respective Library Manager components 810.

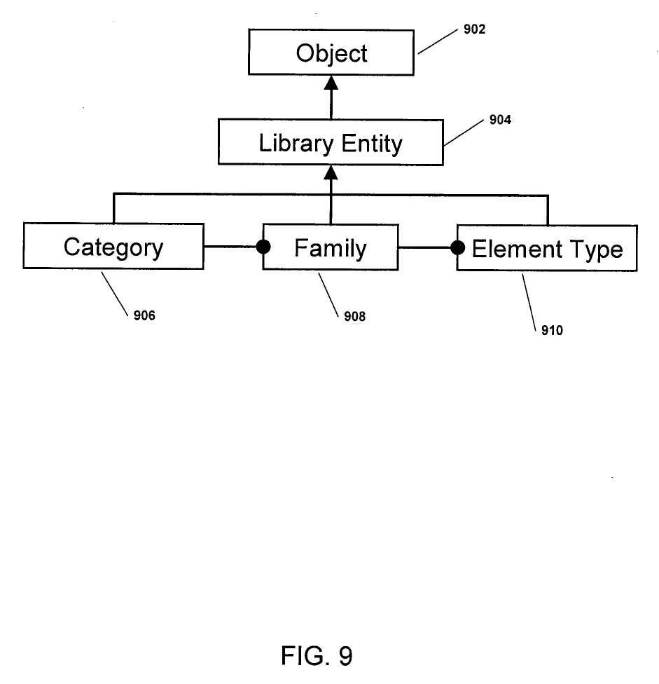

FIG. 9 is a representation of the domain model implemented by the extensible platform Library Manager of FIGS. 1-5. The viewers of FIG. 8 operate on data that is configured according to the domain model of FIG. 9. The Object block 902 represents a Java class that contains the Library Entity class 904, which contains BEMs. The file structural relationships are shown by the lower rung of the diagram, which indicates that a Category class 906 contains Family (Building Element) objects 908, which contain Element Type objects 910. For example, a Category might correspond to Door or Window, a Building Element might correspond to Entry door or Sliding door, or Casement window or Awning window, and Element Type would correspond to particular dimension or finished doors or windows.

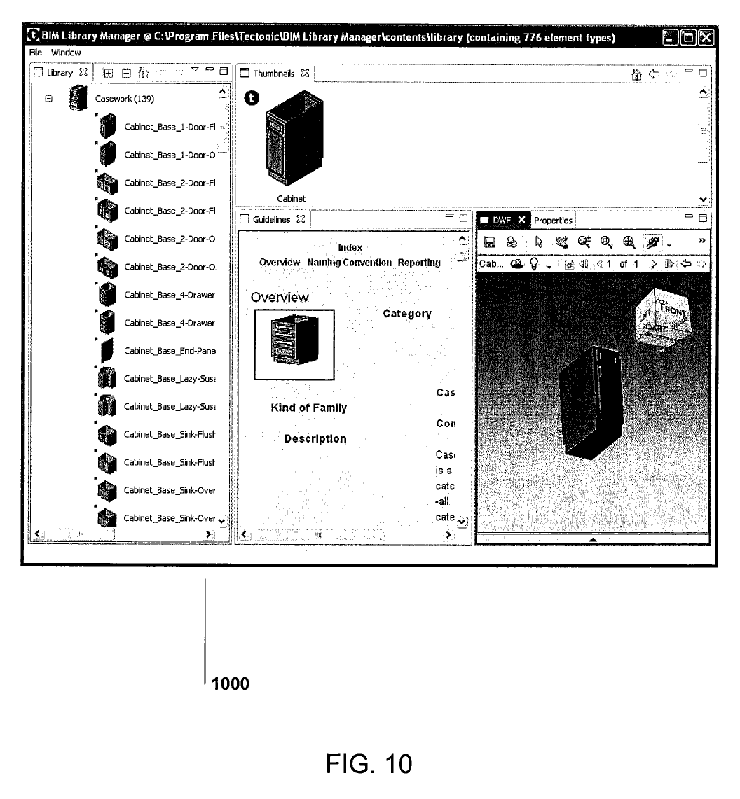

FIG. 10 is a screenshot of the Library Manager window display 1000 at a host computer showing details for a configuration group of panes. FIG. 10 illustrates the flexibility for displaying the panes. In FIG. 10, four of the panes (Library, Thumbnails, Guidelines, DWF) are visible, while a fifth (Properties) is shown in a tab view behind the DWF pane. The relative sizes and positions of all five panes in the Library Manager window can be manipulated by a user of the Library Manager application. Thus, by utilizing the five Viewers in conjunction with the Eclipse integrated toolset, the Library Manager provides greater flexibility in permitting the user to view precisely the information of greatest importance to the user in a desired display configuration.

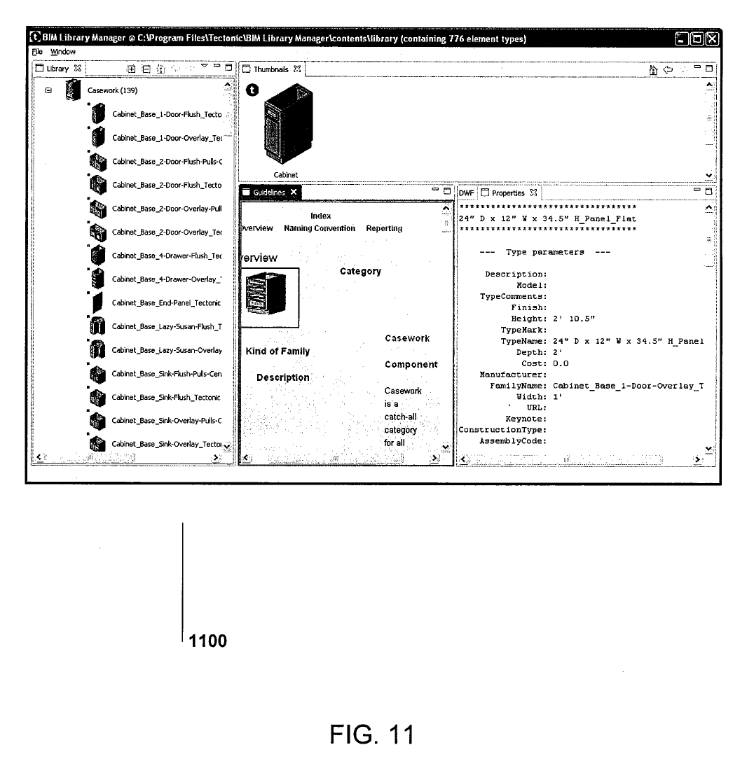

FIG. 11 is a screenshot of the Library Manager window display 1100 at a host computer for a configuration similar to that of FIG. 10 except for the exchange of Properties view for DWF view in the foreground. FIG. 11 shows that the Properties pane and DWF pane have switched foreground and background positions in a tab view. It should be noted that any of the other panes could be placed in a tab view or could be moved around on the user's display, as desired.

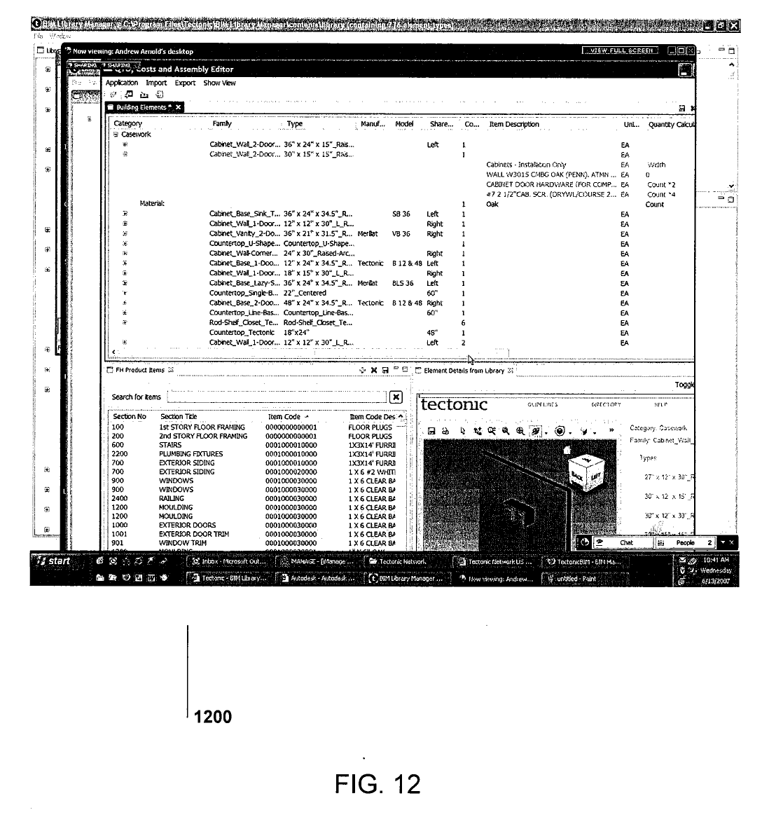

FIG. 12 is a screenshot of the Library Manager window display 1200 at a host computer showing the assembly editor extension plug-in. As noted above, the assembly editor is provided to permit a user to define building components called assemblies, which in turn support effective quantity take-off and cost estimation functions. In this way, a user can define assemblies in accordance with the associated BIM authoring application and those assemblies can become part of the available product library.

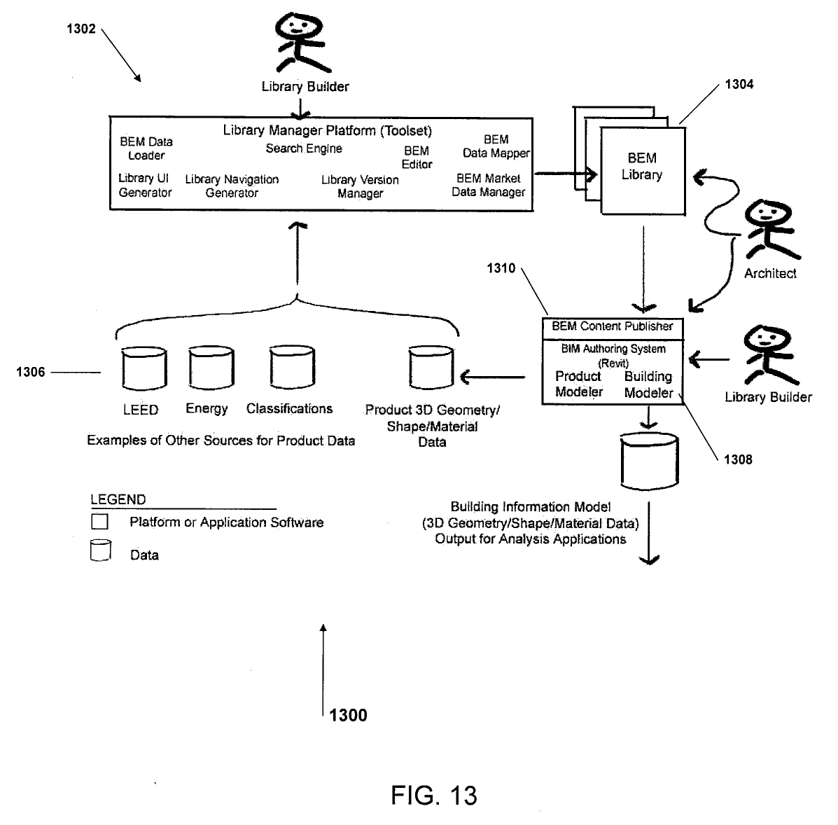

FIG. 13 is an illustration of a BIM system 1300 such as the systems illustrated in FIGS. 1-5 with a BIM Toolset 1302 (also referred to as the Library Manager platform). FIG. 13 shows various entities that might have input into the system and produce BEMs for the BEM Libarary 1304. For example, a Library Builder can use the BIM Toolset to add BEMs to the Library as described above. The Library Builder would utilize the BIM Toolset by making use of the illustrated components, including the BEM Data Loader, the Search Engine, the BEM Editor, the BEM Data Mapper, the Library UI (Page) Generator, Library Navigation Generator, Library Version Manager, and BEM Market Data Manager. FIG. 13 indicates that various sources 1306 may contribute to the data that can be manipulated with the Toolset 1302, including sources such as existing library databases for 3D geometries and shapes and materials, LEED specifications for environmental or “green” ratings (for the Leadership in Energy and Environmental Design (LEED) specifications of the “Green Building Rating System”), and energy and other classifications.

FIG. 13 shows that Library Builders also can utilize BIM authoring systems 1308, such as the Revit® product mentioned above, in creating and maintaining product libraries, which interface to BIM systems. The BIM authoring systems provide data that is, in turn, provided to or utilized by, the Tectonic BIM Toolset (Library Manager). The BEM Content Publisher 1310 can locate the BEM files of the BIM authoring system in the file system of the host computer system (the system on which the BIM authoring system is installed) and can process them into suitable format for use by the Toolset. That is, the Content Publisher can produce the correctly formatted file types (e.g. *.html, *.jpeg, *.xml, *.dwf, *.txt) stored in proper system data locations for use by the Toolset.

Architects comprise another entity or group of users who might have input to, or use for, the toolset described herein. As shown in FIG. 13, architects utilize the Tectonic BEM Library and a BIM Authoring System. With the Tectonic BIM Toolset, architects (who can also contribute to building libraries) can use the BIM Authoring System to design and lay out complex building structures and set forth implementation schedules and track costs and manage component inventories, thereby greatly assisting the contracting and construction process.

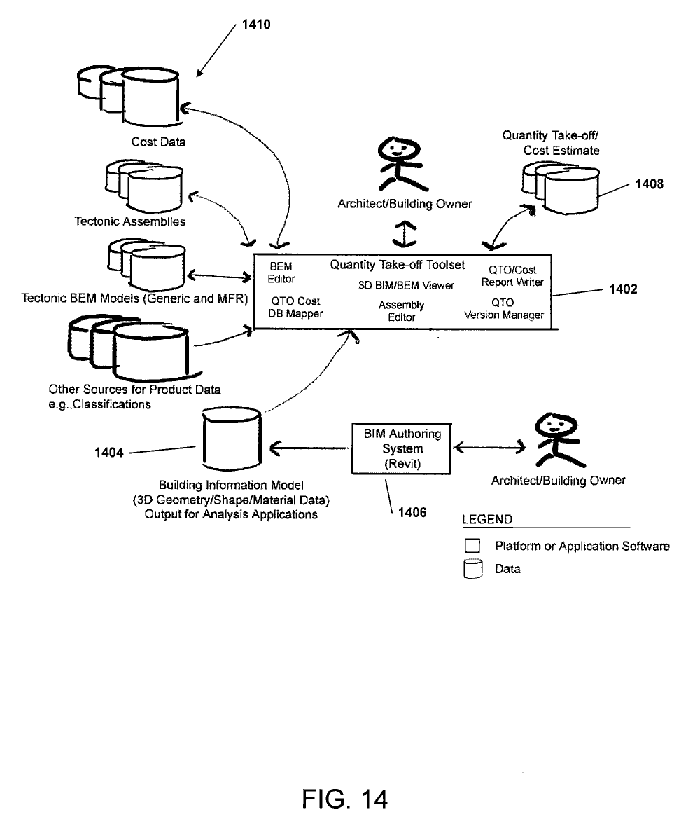

FIG. 14 is an illustration of a Quantity Take-Off Toolset 1402 that can be used for tracking usage of component parts from the Virtual Product Library in connection with a BIM system such as the systems illustrated in FIGS. 1-5. The Quantity Take-Off Toolset is especially useful in determining the actual number of components necessary for an assembly and is useful in tracking parts selection and demand. The toolset is provided in addition to the core Library Manager platform, such as illustrated in FIG. 13. As indicated in FIG. 14, an Architect/Building Owner develops a building structural plan 1404 using a BIM Authoring System 1406, such as the Revit® system described above. The virtual building model is utilized by the Quantity Take-off Toolset 1402 and, through the Architect/Building Owner or other end user, generates costs estimates 1408 for component parts (i.e., Quantity Take-off data) and interfaces with a variety of data sources 1410, including cost data, Tectonic Product Library assembly data, Tectonic Products library database, and other data sources, such as classification information and the like.

FIG. 14 shows that the Quantity Take-off Toolset 1402 includes components such as a BEM Editor, a 3D BIM/BEM Viewer, a Quantity Take-Off/Cost Report Writer, a Quantity Take-Off Cost Database Mapper, the Tectonic Products Assembly Editor to help define the Tectonic assemblies, and a Quantity Take-Off Version Manager.

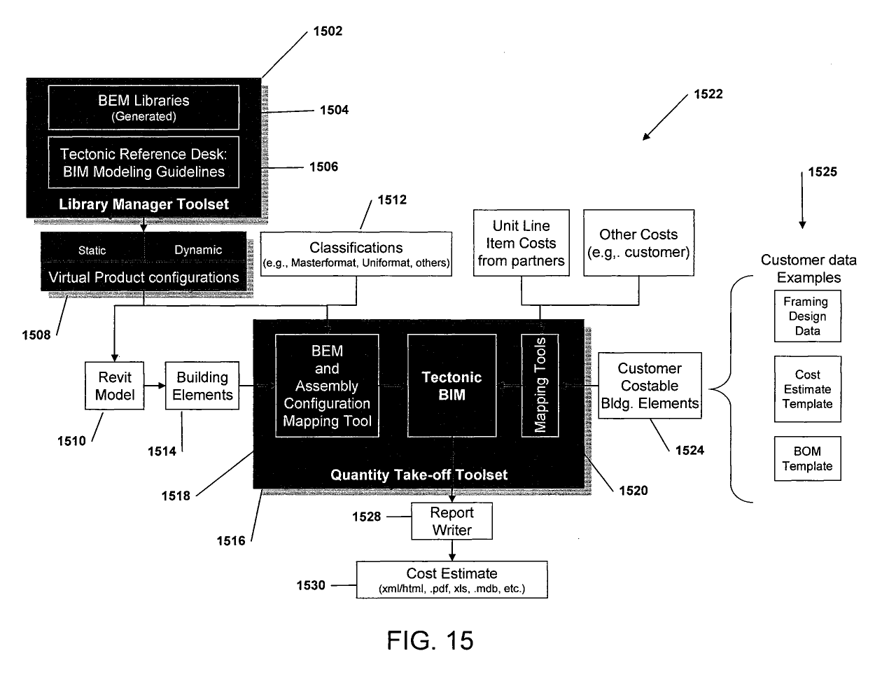

FIG. 15 is an illustration of the information work flow of the system illustrated in FIG. 1. FIG. 15 shows that the Virtual Product Library Toolset 1502 includes BEM Libraries 1504 and also includes a Tectonic Reference Desk component 1506 that provides modeling guidelines. The Toolset provides virtual product configurations 1508 that can include both static and dynamic configuration information. The information can include data about generic virtual products and particular virtual products that are offered by building product manufacturers or sellers. This product information is configured so as to interoperate with data and systems from a variety of sources.

The BEM virtual product libraries 1504 can be automatically generated by the system from existing data and are adapted to support flexible data integration with multiple sources and systems. That is, the system can receive data in a variety of forms and reformat the data where necessary to make the data easily available to users of the system. The virtual product libraries 1504 can assist the user in locating products, selecting products, and specifying products. The libraries also provide a convenient means of distributing building element models and updating them, and also provide a data source from which interoperating computer applications can generate parts counts and assembly costs and the like. The products are virtual products in the sense that they are referenced from a computer data store. The products may be particular or manufacturer-specific, in that the product corresponds to a commercially available item and has particular specifications, or the product may be generic, in that the product does not correspond to any particular product available from any particular manufacturer or supplier, but has specifications or features that are common for the product type or family.

The reference desk component 1506 provides best practices and guidelines for naming and modeling of products and assemblies, for data management and operational considerations. Such practices and guidelines can be implemented into the modeling application, such as by spell-check features and the like. Thus, users are encouraged to be compliant with the naming and modeling guidelines. A computer building model 1510, such as provided by the Revit® authoring tool or the like, utilizes the virtual product configurations and Classifications 1512 to generate building elements 1514. The reference desk component 1506 can be provided in the nature of a “Help” menu or other documentation that can be easily accessed and read by system users.

The Quantity Take-Off Toolset 1516 provides components for data extraction and mapping (to identify building elements to products and assemblies that are suitably configured for the model at hand) and for product and assembly editing (to assign products to assemblies), and for reporting (to specify formats, file types, and databases for producing reports). The Product Library Toolset 1502 and the Quantity Take-off Toolset 1516 provide tools that can interface with building information management systems and together provide a rich toolset of applications that can be used to edit and modify the virtual products that can be specified for a project. For example, the toolsets 1502, 1516 can provide user interfaces for importing and exporting data files for BIM systems, editing information on virtual products for system databases, creating and specifying assemblies via a Product and Assembly editor function, assigning products to assemblies with mapping tools, and specifying report formats such as Cost Estimate reports, database interfaces, file types, and the like.

The Toolset 1516 receives the building elements information relating to the building model and also receives classifications data 1512 at a Virtual Product and Assembly Configuration Mapping Tool 1518. A Mapping Tools component 1520 receives cost data 1522 and Customer Cost-able building elements 1524 taken from customer data sources 1525, such as framing design data, cost estimate templates, and BOM templates. The Product and Assembly Configuration Mapping Tool 1518 produces a mapping of virtual products to assemblies and their components, and a Tectonic BIM component 1526 uses mapping tools to manipulate cost information in conjunction with the product-assembly mapping, from which the Tectonic BIM component can generate data for a Report Writer 1528, which produces a cost estimate report 1530. The cost estimate report can be produced in a variety of output formats that will be familiar to those skilled in the art, such as xml, html, pdf, spreadsheet, text document, and the like.

The system components such as the toolsets and libraries can exchange data and communicate across networks by using platform-independent computing standards. For example, the system can preferably utilize techniques such as communicating over Internet Protocol (IP) networks, and utilizing Web services, Java progranuning, Rich Client Platform (RCP) configurations for Web and desktop applications, standard, well-known database interfaces, and open source application integration framework where applicable.

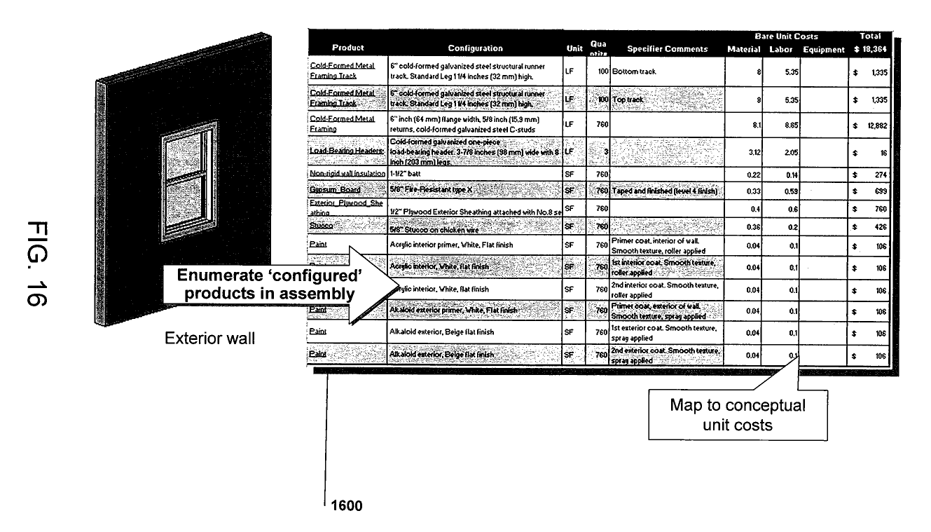

FIG. 16 is a diagrammatic illustration of a computer display 1600 of information maintained by the systems of FIGS. 1-5 produced with the Library Manager application for an exemplary named assembly called “exterior wall”. The display information of FIG. 16 shows that an assembly called “exterior wall” has been specified as including components (products) such as cold-formed metal framing track, cold-formed metal framing, load-bearing headers, non-rigid wall insulation, gypsum board, exterior plywood sheathing, stucco, paint, and the like. The Quantity Take-off Toolset can be used to provide the mapping of products to assemblies, as described herein. The information in the display table can be provided by means of manual input or by being imported from databases associated with the host computer system. For example, costs can comprise budget amounts or estimated values, or can be imported from cost tables or catalogs of products.

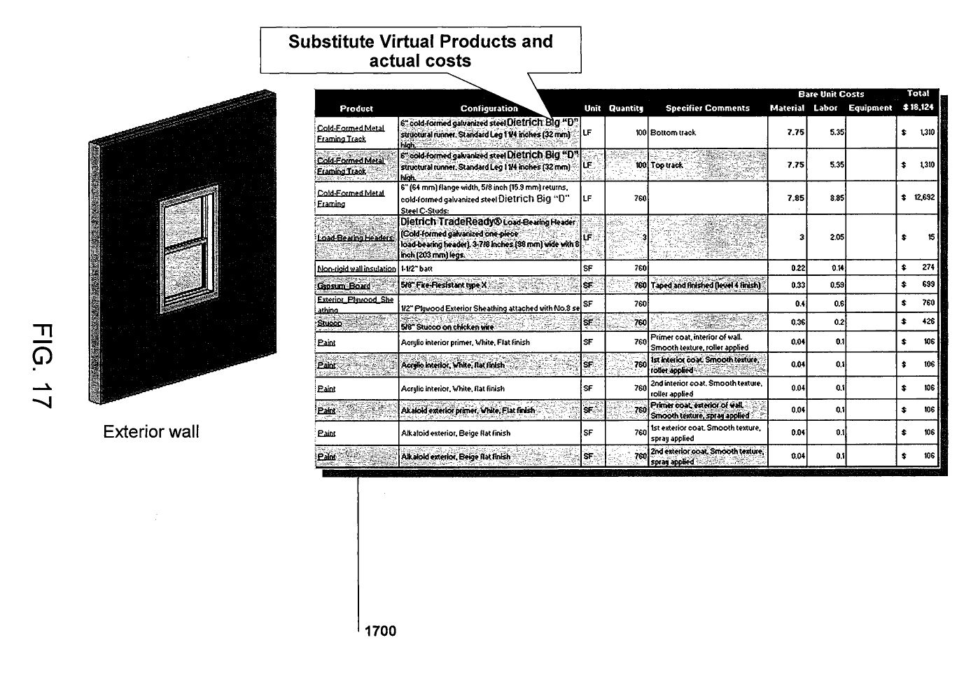

FIG. 17 is a diagrammatic illustration of a computer display 1700 for the “exterior wall” assembly of FIG. 16 showing the addition of further assembly details. FIG. 17 shows that the mapping tools of the Toolset can be used to incorporate detailed construction and component information for the assembly. For example, FIG. 17 shows particular commercially-available products that have been identified for a particular configuration of the components in the “exterior wall” assembly. The mapping tools can be used to edit the information on an iterative or incremental basis, so that additional information (such as identification of particular products or components) can be incorporated as such information is determined. The display (and corresponding information in the computer database from which the display is generated) is automatically updated as needed, such as for recalculation of costs, in response to identification of particular virtual products and in view of their corresponding actual costs.

As described herein, the product library contains virtual products, also referred to herein as building elements, that represent components of a building. The assembly editor operates on the library products to define multiple building assemblies that determine the virtual representation of the building. That is, a building virtual representation is comprised of multiple building assemblies. Each building assembly comprises a data object with inference rules that determine quantity information concerning piece parts contained in the building assembly, and is comprised of virtual products from the product library.

The virtual products that can be produced with the extensible platform of the disclosed embodiments comprise a set of parameterized instances of the BEM data objects, thereby providing a virtual representation of the building such that the BIM project and associated BEM objects can be viewed and manipulated by the user through the user interface comprising the extensible platform, described in the present embodiments as the Library Manager. Through the user interface, a user can manipulate the virtual product library to specify the parameterized instances and the building assemblies for the BIM. A quantity take-off engine can apply cost data concerning the assemblies to produce a cost estimation report for the materials cost of the building.

In this description, references to “Tectonic Virtual Product” (TVP) shall be understood to be references to building element model (BEM) descriptions for products and accompanying software tools produced by Tectonic Network, Inc. and the terms TVP and BEM may be used interchangeably. In accordance with the invention, a computer toolset for use with BIM authoring systems supports creation, editing, and manipulation of BEMs for BIM systems. More particularly, with the toolset, a user can define and manage BEMs from product information that exists in different data files and formats. The product information can include current pricing information, component parts composition of assemblies and other piece part collections or building components that can be defined by the user. The BEMs can include 3D geometry Computer Aided Design (CAD) representations of physical products and assemblies such as windows and doors, and non-geometric product information that may be represented in the CAD model or integrated from external databases and forms of digital media. The BEMs may contain other BEMs, rules for calculating quantities and unit costs, and the ability to represent predicted and measured product performance behavior for engineering analysis. Thus, the BEM model logically unifies CAD, data, and performance behavior representations of products and assemblies. The BEM specification also differentiates the BEM from the BIM model of a physical or designed building, in which instances of the BEM can be placed.

The Tectonic toolset also permits users to dynamically add attributes to BEM definitions and thereby extend and enrich the BEM definition beyond information obtained from external sources. Users can programmatically generate, and manage BEM Libraries. The toolset enables the organization of BEMs by different classification systems and easy customization of the Library user interface for navigating to products for different markets/regions. The domain model of the Toolset cleanly separates the representation of physical building products from organization and classification systems that are used to categorize physical products e.g., CSI “Masterformat” or “Uniformat” systems. Given the specification of a classification schema, the Toolset enables a user to flexibly map a BEM to one or more classifications and it automatically generates the user interface navigation hierarchy that organizes BEMs in a Product Library. The presentation layer of the generated Product Library can be easily customized for a corporate branding (i.e., look and feel) by using conventional well-known Internet technology.

The Tectonic toolset generates BEM (or Virtual Product) Library pages from data that exists in a variety of formats. For example, the Tectonic toolset can be configured to interface with files in the format of the Revit® product from Autodesk, Inc., which produces files comprising 3D representations of building components, and also interface with files in the format of CSI Masterformat Classifications. The Tectonic system can interface with data from other sources relating to components, such as price, availability, energy analysis, and the like. These abilities support easy customization of the library for cases where the navigation hierarchy to BEMs and the structure of a BEM model changes by region.

The Tectonic toolset also permits user to find, search, and select BEMs from a BEM Library and place selected BEMs in a Building Information Model (BIM) authoring system such as the Revit® system referred to above. With the Tectonic toolset described herein, users can collect BEM Library usage behavior as market data to support sales lead generation for building product manufacturers.

In one embodiment, the primary functional components of the toolset for the BEMs as described herein include:
a) BEM Editor: with which users can define (specify) and modify BEM data models;
b) BEM Data Loader: for users to name product data sources, load product data;
c) BEM Data Mapper: to map data from a data source to a BEM;
d) BEM Library UI Navigation Generator; to generate hierarchical UI navigation for finding products;
e) BEM Library Product Page Generator, which generates pages for viewing BEM information through associated BIM authoring or host software;
f) BEM Search Engine: supports query for BEMs by example, text search, and the like;
g) BEM Version Manager: Updates and manages versions for BEMs;
h) BEM Market Data Manager: Collect usage behavior including basic Library click stream and also user intent e.g., collect the configuration parameters of a BEM selected from the Library for a specific BIM project in which the BEM is placed.

The Tectonic toolset can be used to develop the Tectonic Virtual Product Library, which can also be used and extended by software consultants that custom develop Tectonic Virtual Product Libraries.

The toolset can include a computer implemented Quantity Take-off (QTO) Toolset comprising a suite of extensible software tools that enable end-users to:
a) Edit (Add, Modify, Delete) BEM data models;
b) Load a BIM database or model from a BIM authoring system like Revit;
c) Map the BIM elements to BEM data models;
   1) For BIM elements that represent Assemblies, e.g., Walls, Roofs, Floors, Ceiling Systems, map the assembly to a collection of BEM data models that are constituent to the assembly e.g., wood stud framing, insulation, and gypsum board for a wall assembly;
   2) The QTO system calculates quantities for the constituent Tectonic Products of assemblies from the raw quantities that are extracted from the BIM;
d) Load a Cost database;
e) Map BIM elements to Cost Database line items;
f) Interactively modify Cost Database Unit Costs and view project cost totals;
g) Define and generate Quantity Take-off and Cost Estimate reports;
h) Visualize the BIM 3D model in the Quantity Take-off system and query the model by selecting BIM elements to view their quantities and costs;
i) Save Quantity Take-offs/Cost Estimates;
j) Compare Quantity Take-offs/Cost Estimates.

The A toolset can be provided for editing and maintaining the Virtual Product Library. The toolset permits users to edit BEMs, manipulate BEMs in collections, manage cost data and apply the data to BEMs, and generate estimates and reports. The primary functional components of the Virtual Library Toolset include:
a) BEM Editor (redundant with product editor described in TVL Toolset);
b) BEM Assembly Editor
c) QTO Cost Database Mapper
d) 3D BIM Viewer (provided by vendor e.g., Autodesk .DWF viewer);
e) QTO/Cost Estimate Report Writer
f) QTO/Cost Estimate Version Manager.

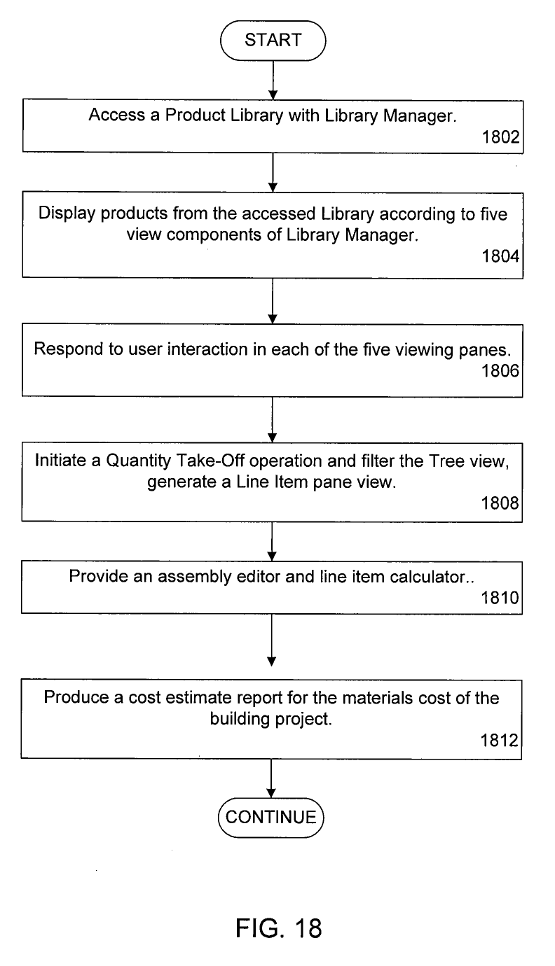

FIG. 18 is a flowchart of computer operations performed by the Library Manager system illustrated in FIGS. 1-5 to produce and manage a building model and to produce cost estimates using the parameterized BEMs in accordance with the invention. In the first operation, indicated by the flow diagram box numbered 1802, a user accesses a product Library through a user interface of the host computer system. As described above, the Library contains BEMs or virtual products that comprise parametrically described data objects representing components of a building or other structure. In the next operation, at box 1804, products from the accessed Library are displayed according to the five component viewers described above. The five views include the Library Tree view, Thumbnail view, Guideline view, DWF view, and Properties view.

At box 1804, a user can select products for a project or building and corresponding panes of the five viewers will generate the appropriate information for display. At box 1806, the system can respond to user interaction with each of the panes. For example, a user can maneuver the DWF view to move a 3D representation of the selected product. The Library Manager will respond to user manipulation in each of the five panes, as appropriate.

At box 1808, the system initiates a Quantity Take-Off operation. The initiation will typically be in response to user selection, such as by drop-down menu or the like through the Library Manager interface. The processing of box 1808 involves filtering the Library Tree pane of the computer display so that only appropriate families are placed in the display, corresponding to families in the selected project of concern. In addition, box 1808 generates a Line Item pane that displays line items from automatically accessed databases. The pane permits the user to carry out drag-and-drop action to associate unit line items to Revit elements (or elements of whatever BIM authoring tool was used).

Next, at box 1810, the Library Manager adds an assembly editor and line item calculator window to calculate quantities of constituent products. Thus, the QTO operation changes the Library Manager display through the filtering operations and additional pane view, and is thereby an extension of the Library Manager platform (i.e., the Library Tree view) that provides additional functionality. The QTO Costs and Assembly Editor window is illustrated in FIG. 12, which shows panes for Building Elements, Product Items, and Element Details from Library. Next, at box 1812, the QTO operation determines total cost of all the assemblies within the project and produces a cost estimate report for the materials cost of the project.

Cost estimates can be prepared using the data object instances of the building. The system can determine total cost of each specified building assembly. In determining total cost of assemblies, the system utilizes the product components that include sufficient detail concerning the products and piece parts that comprise a building assembly to calculate total cost. For example, the system can determine total cost of a unit portion of exterior wall using a parameterized definition of an exterior wall that includes all component parts, identified by manufacturer where possible, and multiplies the costs for the components necessary in a unit portion (e.g. per linear foot). After unit cost of the assemblies is known, at box 810, the system can apply the cost data concerning the piece parts for each unit component through a quantity take-off toolset that produces a cost estimation report for the materials cost of the building. That is, for each assembly for which unit cost has been determined, the system can calculate estimated total cost. For example, the system can automatically use cost per linear foot of exterior wall and amount (total linear feet) of exterior wall required for the building to find an estimated cost for the exterior wall assemblies. Performing a similar task for all of the various assemblies in the building provides a cost estimate report for the building.

As noted above, the operations described herein can be performed through computers communicating over networks. The illustrated components, such as the Library Manager components and extended applications, can be implemented on a variety of computing devices, such as desktop computers, laptop computers, and servers. A user can access the components through a computer that includes the requisite software and communications interface, such as a Web browser or other application for communication with the BIM authoring system and associated software applications.

In some embodiments as described herein, the BIM Library Manager includes a default Library that contains Tectonic-developed content and allows users to create and view Libraries. Users can flexibly create a master office library, a library for each Project, a library for each building type, etc. After selecting a library, users can find Revit Families hierarchically by category and type, through 3D visualization of thumbnails and DWF views, and by searching and inspecting property sets. Upon Selection, users can Drag-and-Drop a Family into a Revit project or save it to a directory folder. In addition, users can view Guidelines that describe best practices for modeling on the Revit platform. The guidelines include basic modeling advice for each Revit Type (Door, Window, etc.), recommend Family and Type name conventions, and offer tips and tricks of modeling for ‘count ability’ as well as design representation. The BIM Library Manager features a customizable user interface based on Rich Client Platform and plug-in architecture technology that allows you to flexibly display, arrange, and size each application pane.

Embodiments of the BIM Library Manager can be provided with a library of Revit families that are custom-developed by Tectonic. These parametric family models are designed for quality, re-use across projects, and utility for design representation and “count-ability” for quantity take-off. A special Tectonic logo shows in the Library thumbnail for each Revit family developed by Tectonic. Users will have the option to receive regular updates and additions of generic and manufacturer specific content developed by Tectonic. Additionally, Tectonic can deliver content on-demand by special agreement.

A Family Content Publisher™ is available as a companion product to the BIM Library Manager. It is a Revit® Architecture 2008® add-on that automates the extraction and creation of artifacts (thumbnail images, 3D DWF models, property sets) from Families for presentation in the Library.

Considered together, the BIM Library Manager and the Family Content Publisher programmatically generate libraries from Family files that exist in the file system or in a project. When a user creates Revit families or obtains them from other sources, the user can easily add them to an existing library or a new library by using these two tools. The BIM Library Manager is configured to install on the desktop or to a Local Area Network. The Library Manager can install optionally to an application server maintain at a user site or outsourced to an Internet Service Provider.

The Library Manager system architecture weaves together a variety of components:
(a) Tools and frameworks based on the Open Services Gateway initiative (OSGi), which implements a complete and dynamic component model. The OSGi specifications are used in applications ranging from mobile phones to the open source Eclipse IDE.
(b) Tools and frameworks that run on the Java Runtime Environment Virtual Machine.
(c) The Eclipse open development platform that consists of an extensible development platform and plug-in architecture that supports multiple software languages and data sources, runtimes and application frameworks for building, deploying and managing software across the entire software lifecycle. The Eclipse community is supported by major IT solution providers, including IBM, Borland, Oracle, Sybase, BEA, Actuate, Google, and others that have contributed runtimes and application frameworks that are available to use, extend and brand.
(d) Amazon Elastic Compute Cloud: a service that provides scaleable computing power on demand over the Internet. It lets developers use Web service interfaces to requisition machines, load them with custom application environments, manage a network's access permissions, and run images using as many or few systems as necessary with no capital costs.
(e) Microsoft .NET technology to develop components that interact directly with Autodesk products, using Autodesk product Application Programming Interfaces.

The previous description of the disclosed embodiments is provided to enable any person skilled in the art to make and/or use the present invention. Various modifications to these embodiments will be readily apparent to those skilled in the art, and the principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A computer-implemented library manager system comprising:
an application interface to a host computer system;
an extensible platform having multiple program classes that associate with model information from multiple sources and adapted to interact with application extensions of the extensible platform, the program classes including a Library Tree view, a Thumbnail view, a Guideline view, a DWF Image view, and a Properties view.

2. The system of claim 1, further comprising:
a virtual product library that contains virtual products that comprise parametrically described data objects that represent components of a building and are processed by a virtualization software application to produce a set of parameterized instances of the data objects, thereby providing a virtual representation of the building such that the virtual representation can be viewed and manipulated by a user;
an assembly editor that operates on the virtual products to define multiple building assemblies, wherein a building assembly comprises a data object with inference rules that determine quantity information concerning piece parts contained in the building assembly, and wherein the building assemblies determine the virtual representation of the building;
a user interface with which a user can access the virtualization software application and the virtual product library to specify the parameterized instances and the building assemblies for processing by the virtualization software application.

3. The system as defined in claim 2, wherein the virtual products include sufficient detail concerning the virtual products and piece parts that comprise a building assembly to determine total cost of the building assembly.

4. The system as defined in claim 3, further including a toolset that applies cost data concerning the piece parts to produce a cost estimation report for the materials cost of the building.

5. The system as defined in claim 4, wherein the cost estimation report includes a set of specifications for piece parts of the building and a set of vendor product candidates that identifies products that meet the piece part specifications.

6. The system as defined in claim 5, wherein the toolset communicates with a computer network and the vendor product candidates are identified from data retrieved from a network computer.

7. The system as defined in claim 2, further including:
a data loader that communicates with a computer network to locate a user virtual product library and provide appropriate data objects to the virtualization software application;
a page generator that processes the provided data objects to produce a computer display presentation of the corresponding virtual products.

8. The system as defined in claim 2, wherein the user interface further includes a search engine that communicates with a computer network and locates vendor products that satisfy specifications for the virtual products that comprise the building assemblies.

9. The system as defined in claim 2, wherein the user interface further includes a version control module that maintains version information concerning iterations of the building virtual representation.

10. A method of processing computer data of a building information management system, the method comprising:
accessing a virtual product library through a user interface, wherein the virtual product library contains virtual products that comprise parametrically described data objects that represent components of a building;
defining multiple building assemblies, wherein a building assembly comprises a data object with inference rules that determine quantity information concerning piece parts contained in the building assembly, and wherein the building assemblies determine a virtual representation of the building;
producing a set of parameterized instances of the data objects and building assemblies for processing by a virtualization software application, thereby providing a virtual representation of a building such that the virtual representation can be viewed and manipulated by a user through the user interface.

11. The method as defined in claim 10, further including determining total cost of the building assembly, wherein the virtual products include sufficient detail concerning the virtual products and piece parts that comprise a building assembly to calculate total cost.

12. The method as defined in claim 11, further including applying cost data concerning the piece parts through a quantity take-off toolset that produces a cost estimation report for the materials cost of the building.

13. The method as defined in claim 12, wherein the cost estimation report includes a set of specifications for piece parts of the building and a set of vendor product candidates that identifies products that meet the piece part specifications.

14. The method as defined in claim 13, wherein the quantity take-off toolset communicates with a computer network and the vendor product candidates are identified from data retrieved from a network computer.

15. The method as defined in claim 10, wherein the user interface comprises:
a data loader that communicates with a computer network to locate a user virtual product library and provide appropriate data objects to the virtualization software application;
a page generator that processes the provided data objects to produce a computer display presentation of the corresponding virtual products.

16. The method as defined in claim 10, wherein the user interface further includes a search engine that communicates with a computer network and locates vendor products that satisfy specifications for the virtual products that comprise the building assemblies.

17. The method as defined in claim 10, wherein the user interface further includes a version control module that maintains version information concerning iterations of the building virtual representation.

18. A computer-implemented building information management system comprising:
a user interface with which a user can access a virtualization software application and a virtual product library;
a data loader that communicates with a computer network to locate a user virtual product library and provide appropriate data objects to a virtualization software application, wherein the user virtual product library contains virtual products that comprise parametrically described data objects that represent components of a building and are processed by the virtualization software application to produce a set of parameterized instances of the data objects;
a page generator that processes the provided data objects to produce a computer display presentation of the corresponding virtual products, thereby providing a virtual representation of the building such that the virtual representation can be viewed and manipulated by a user through the user interface;
an assembly editor that operates on the virtual products to define multiple building assemblies, wherein a building assembly comprises a data object with inference rules that determine quantity information concerning piece parts contained in the building assembly, and wherein the building assemblies determine the virtual representation of the building.

19. The system as defined in claim 18, wherein the computer display presentation of the page generator comprises a Web browser display page.

20. The system as defined in claim 19, wherein the page generator provides the computer display presentation through XML processing operations.

21. The system as defined in claim 19, wherein the computer display presentation comprises a sheet of a spreadsheet application.

22. The system as defined in claim 19, wherein the virtual products include sufficient detail concerning the virtual products and piece parts that comprise a building assembly to determine total cost of the building assembly.

23. The system as defined in claim 22, further including a quantity take-off toolset that applies cost data concerning the piece parts to produce a cost estimation report for the materials cost of the building.

24. The system as defined in claim 23, wherein the cost estimation report includes a set of specifications for piece parts of the building and a set of vendor product candidates that identifies products that meet the piece part specifications.

25. The system as defined in claim 24, wherein the quantity take-off toolset communicates with a computer network and the vendor product candidates are identified from data retrieved from a network computer.

26. A computer method of managing an information model, the method comprising:
accessing a product information library;
displaying products from the accessed library in accordance with an extensible platform having multiple program classes that associate with model information from multiple sources and adapted to interact with application extensions of the extensible platform, the program classes including a Library Tree view, a Thumbnail view, a Guideline view, a DWF Image view, and a Properties view; and
responding to user interaction in each of the five viewing panes.

27. The method as in claim 26, further including:
initiating a quantity take-off operation for a project of the information model;
providing an assembly editor and line item calculator for the information model; and
producing a cost estimate report for the materials cost of the project.

28. The method as in claim 27, wherein the quantity take-off operation comprises:
filtering the tree view; and
generating a line item pane view.
